(19) United States
(12) Patent Application Publication
(10) Pub. No.: US 2005/0226953 A1
(43) Pub. Date: Oct. 13, 2005

(54) Pre-mix grout package

(76) Inventor: Avinesh Prasad, San Mateo, CA (US)

Correspondence Address: Avinesh Prasad, 1203 Cobb Street, San Mateo, CA, 94401, US

(21) Appl. No.: 11/101,719

(22) Filed: Apr. 8, 2005

Related U.S. Application Data
(60) Provisional application No. 60/560,437, filed on Apr. 8, 2004.

(51) Int. Cl. D04D 7/06; A01J 25/12

(52) U.S. Cl. 425/97; 264/211.21

(57) ABSTRACT

A pre-mix grout package includes a pre-packaged and air sealed mixed grout, either sanded or non-sanded, material. Pre-mix grout can be of various texture and colors. The pre-mixed grout package can be designed to include a refillable tube. A modified design structure is provided for improving the method of applying grout to the title spaces or joints. Pre-mix grout can be packaged in various color tones in conventional caulking tube currently utilized in the industry. Modified cap design includes the tubing cap or tip to be inter-changeable via screw, snap, or bonded methods. As described, the cap can be cut at certain incision points to control the pre-mix material flow. A caulking extrusion gun can be utilized to extract the pre-mixed grout material to desired applications. This controls the level of job projects at the rate of rapidly applying the pre-mixed grout to the title without having the concern of grout drying in conventional “grout bag”.

### CROSS-REFERENCE TO RELATED APPLICATIONS

To extend the disclosures and findings of the following U.S. Pat. No. 4,461,407 are suggested and required for an understanding of this invention, and such patent is herein incorporated only by reference.

### FIELD OF THE INVENTION

This invention relates to home building and home improvement apparatus and methods related to the installation of materials such as tile, glass, etc. More specifically, this invention relates to apparatus and methods related to the use and application of premixed grout.

### STATEMENT REGARDING FEDERALLY SPONSORED RESEARCH OR DEVELOPMENT

Not applicable

### REFERENCE TO A COMPACT DISK APPENDIX

Not applicable

### BACKGROUND OF THE INVENTION

There have been relatively few innovations in the methods of pre-mixing and applying grout mixtures (i.e., dry mix compound) applied to acrylic base solution or water based solution at the construction site(s). The concept of premixing grout or sanded grout mixtures will revolutionize the manner in which a construction crew works, primarily by saving time in having to mix grout on site. The ability to have a pre-mixed grout package (of various colors) can eliminate the need for any construction crew having to mix grout.

Currently most construction crews have to purchase dry grout mix compound along with acrylic base solution separately. Dry grout is generally packaged in a bag available in various weights of pounds (lbs). Acrylic mixture solution for the grout is generally sold in various weights of liters. Depending on the construction project size, the crew would mix the grout compound and acrylic mixtures prior to application on the tile or marble gaps. Generally, the crew will use a float to pickup and apply grout to the tile/marble. The float is used to remove excess grout from the surface of the tile/marble. Another method often utilized involves a “grout bag” wherein grout is placed in the “grout bag” and squeezed out ejecting the grout onto the tile spaces or joints. This method is generally very disadvantageous because the grout gradually dries out as it is being applied, creating further difficulties during application. It is often the case that most of the grout material is wasted or dried out due to air pockets in the “grout bag”.

Further, a wet sponge or cloth is used to remove the remainder of the grout from the tile/marble surface. This is done to reduce grout glaze from building up on the tile/marble surface. A second crew member works behind the applicator person(s) to quickly remove any or all grout on the tile/marble surface. Usually, the crew is working against time to prevent the grout mixture material from drying out or hardening. Construction crew members have to estimate their project size and amount of grout they are able to apply without having any large quantities drying or hardening before application. Depending on environment temperature, the grout mixture can easily become dry or hardened and it is necessary to waste the grout mixture.

Another method of purchasing pre-mix grout is available to the construction crew members or consumers. Pre-mix grout can be purchased in various liter/gallons sizes of tub type packaging. Users still generally have to use a float device or “grout bag” to apply the pre-mix grout between adjacent tile/marble gaps and remove all excess pre-mix grout with a wet sponge or cloth. Purchasing pre-mix grout does reduce some construction project time of having to mix grout at the project site, however the application time would be the same.

This invention provides an improved dispensing method and apparatus that addresses the deficiencies and needs of other prior methods or knowledge thereof.

### BRIEF SUMMARY OF THE INVENTION

This present invention provides an improved method of packaging pre-mixed grout or any other material thereof in a circular, hollow, and tubular packaging (material storage element 110), similar to caulk packaging. The tube packaging having a distal end from which material can be loaded, and a proximate end from which material may be dispensed. Couped to the proximate end of the material storage element is a packaging tip for focusing the material as it is ejected. The material storage element can be used with a portable gun dispensing apparatus that can be utilized to force a movable plunger originating at the distal end of the material storage element toward the proximate end, thus dispensing material from the material storage element.

Other aspects of this invention allows the packaging tip (120) to be pre-marked for exact incision points, which would only allow certain amounts of pre-mix grout being delivered at a time. This invention addresses the modification of the tip of the tubular package device. The tip is modified to have incision marking points, where approximate 5/16″, ¼″ and ⅛″ cuts, for example can be made. The tip (120) can be designed to be coupled to the material storage element via a threaded screw mount, snap mechanism, heat mount, or simple pressure fit. The tip (120) can be removed and subsequently replaced with a different tip (120). This prevents any contents of the pre-mix material drying out or corroding. Further, tip (120) replacement can allow the user to cut a smaller incision marking if a larger incision had been made previously.

Alternatively, a tapered cap may be utilized that allows for the tip to be closed off from air, as well as having the capability of being used to narrow the tip nozzle either by having a smaller opening because it is made that way or by being cut.

The material storage element can be sealed with a plunger at the distal end to form a tube. This tube can then be loaded into an extrusion gun. This saves the hands from painful squeezing and thus save the grout from drying out. The plunger moves within the tube, and is pushed toward the proximate end via the extrusion gun. The plunger is also removable, allowing the tube to be filled or refilled.

### BRIEF DESCRIPTION OF THE DRAWINGS

FIG. 1; shows the side view of a pre-mix package 100. The pre-mix package is comprised of a material storage element 110 for storing materials such as pre-mix grout, and a tip 120 that is coupled to the material storage element 110. The tip 120 may be coupled to the material storage element via a threaded screw mount, snap mechanism, heat mount, simple pressure fit, and others. Additionally, the tip or nozzle 120 may be comprised of a proximate section that is fixedly attached to the material storage element 110 and a distal section that is coupled to the proximate section. The distal section of the tip may be removed and subsequently replaced with a different distal section. The distal section could be swapped out for a closed ended distal section to prevent the contents of the package from drying out or corroding. Also, the subsequently coupled distal section could then be cut for use, or replaced with another distal section. For example, grout may be pre-mixed, and then loaded in a storage tube. Other pre-mixed materials may include caulk, wedding cake frosting, glue, sealants, adhesives, lubricants, mortar, or any liquid paste or gel fluid.

FIG. 2; shows the side view of a delivery extrusion gun device, 300, loaded with a pre-mix grout package. The extrusion gun delivery device is used for emptying the contents of a tube filled with pre-mixed grout. The trigger, 310, of the gun is squeezed to force a plunger into the rear end of the tube, thus pushing the contents of the tube out.

FIGS. 3 & 4 show a side view of a threaded cap. The threaded cap is screwed onto the tube nozzle package. The threaded cap can allow the user to resize the opening on the tip for application use.

FIG. 5 shows how the pre-mix grout is being applied to tile/marble.

### DETAILED DESCRIPTION OF THE INVENTION

Referring now to the drawings, whereas like reference numbers correspond to the drawing structure and views.

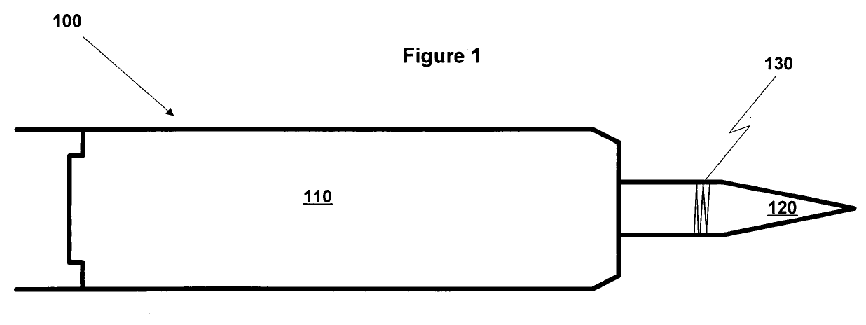

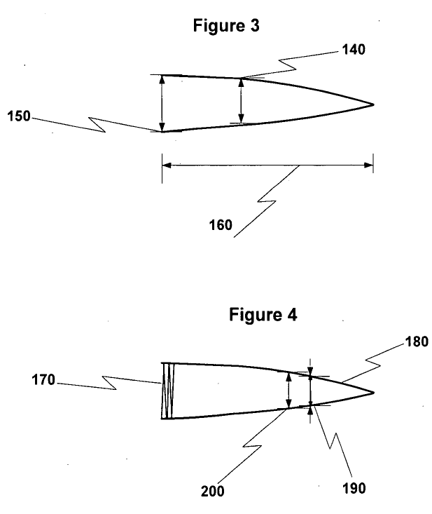

FIG. 1 shows an improved pre-mixed tubular packaging similar to caulk packaging currently utilized in the industry. Tubular container 110 directly holds and encases the pre-mixed grout material and is directly coupled to tip or nozzle 120. Screw tread 130 indicates the treaded embodiment on the external surface of the cap, approximately 50 mm distal from the cap tip point as referenced within FIG. 3. Screw tread 130 as indicated can also be of a single tread embodiment on the coupled tip 120, for snap fit of an external cap as referenced in FIG. 3.

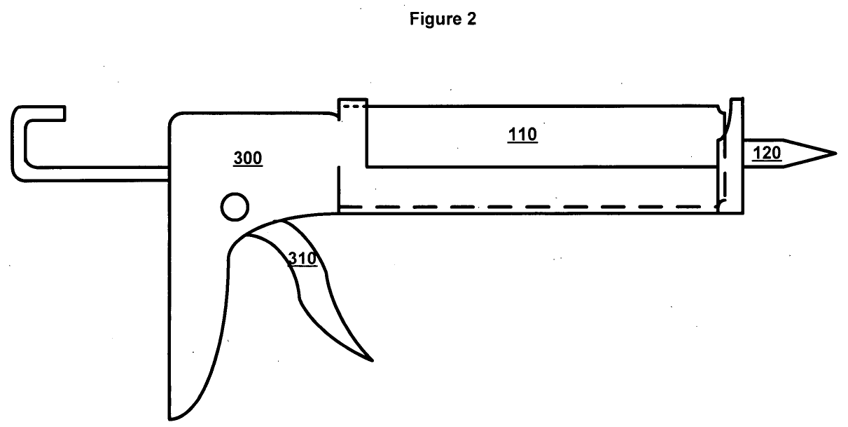

FIG. 2 illustrates as referenced above in FIG. 1, the embodied tubular packaging 110 with attached 120 installed in a dispensing apparatus gun 300. 310 is described as the trigger for the apparatus gun.

FIG. 3 illustrates the cap tip approximate measurements. 140 point indicates the approximate external width of 11 mm. 150 point indicates approximate external opening of 13 mm. 160 point indicates approximate external width of the cap to be 50 mm.

FIG. 4 illustrates the cap with internal treaded 170 at the opening end. The cap has approximate external incision markings as described at point 180 indicates ⅛″, point 190 indicates ¼″, and point 200 indicates 5/16″.

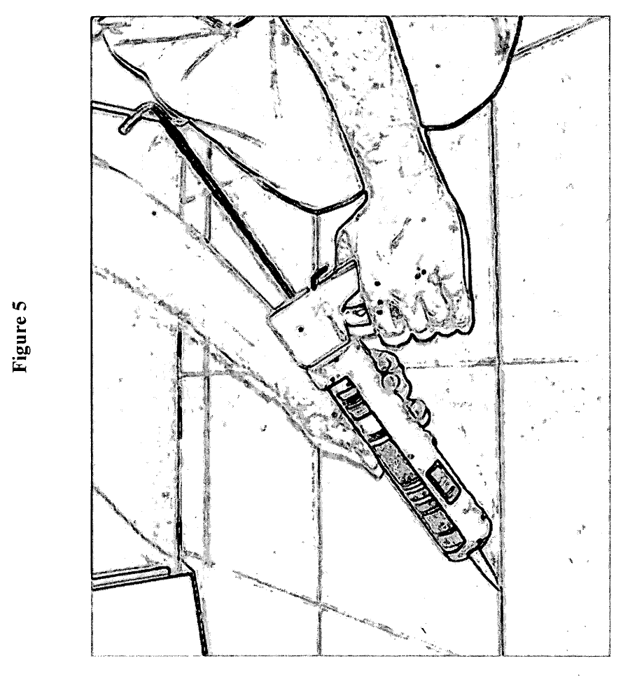

FIG. 5 illustrates the pre-mix grout as applied into the tile or marble spaces.

1. A method of delivering pre-mixed grout comprising of the step of dispensing via a the extrusion gun and pre-mixed grout material contained within a tube package.

2. A method of improving packaging of pre-mixed grout comprising of the steps of packaging a tube with pre-mixed sanded or non-sanded grout.

3. The method of claim 2, wherein the grout may be of various textures and colors.

4. A method of improving packaging of pre-mixed grout comprising of the steps of loading the tube packaging with pre-mixed grout, then loading the tube package into an extrusion gun, and dispensing the content material.

5. A modified apparatus cap comprising of an screw threading end and of a distal section opening end for dispensing the pre-mixed grout material; and can be comprising to be coupled to a nozzle and used as a reduction nozzle or tip.

6. The modified apparatus cap and distal section of the cap in claim 5 comprising to be attached via treaded embodiment on the exterior surface, of bond, of coupled via snap mechanism, of coupled via heat bonding, of coupled via pressure snap fit.

7. The modified apparatus cap and distal section of the cap in claim 5 comprised to be removed by the user, and to be subsequently replaced with a different distal section cap as desired.

8. The modified apparatus cap and distal section of the cap in claim 5 comprised to be used also as closed nozzle distal section; and to prevent the contents of the pre-mixed grout or other material from drying out or corroding.

9. The modified apparatus cap and distal section of the cap in claim 5 comprised of incision cut mark points; and the cap used as the reduction of the opening incision cut points to limit material flow.

10. The modified apparatus cap and distal section of the cap in claim 5 comprising of improving the method and appending of applying pre-mixed grout between various title spaces; and of dramatically reducing material (pre-mix grout) drying or hardening due to air sealed packaging; and of improving material (pre-mix grout) waste amount.

11. The pre-mixed material can be comprising of pre-mixed grout, of caulking, of glue, of sealants, of gel adhesives, of lubricants.

12. A method of delivering pre-mixed grout comprising of the step of combination of claim 1, whereas improving and reducing glaze forming on the title surface, and/or improving of timeline of the project.
